(19) United States
(12) Patent Application Publication
(10) Pub. No.: US 2004/0156985 A1
(43) Pub. Date: Aug. 12, 2004

(54) Process for the application of powder coatings

(76) Inventors: Frank-Dieter Zimmermann, Frontenhausen (DE); Joerg Reiter, Nuernberg (DE)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/719,725

(22) Filed: Nov. 21, 2003

Related U.S. Application Data
(60) Provisional application No. 60/434,247, filed on Dec. 18, 2002.

(51) Int. Cl. B05D 1/12; B05D 3/06

(52) U.S. Cl. 427/180; 427/557; 427/558

(57) ABSTRACT

A process for application of powder coatings to conductive and nonconductive surfaces comprising

a) covering the surface with material which absorb high-energy radiation within a wavelength in the range of 250 to 2,500 nm and having heating rates of more than 50° C. per second and

b) applying a powder coating composition to the covered surface and melting and curing the applied powder coating composition with NIR radiation.

### PRIORITY

This application claims priority from Provisional U.S. patent application Ser. No. 60/434,247 filed Dec. 18, 2002, incorporated herein by reference.

### BACKGROUND OF THE INVENTION

The present invention relates to a process for the application of powder coatings to metallic and non-metallic substrates including covering of the substrate surface.

Powder coatings are typically applied to electrical conductive metal substrates by electrostatic forces. The electrostatic charge on particles of the powder coating allows the application of an even powder layer on the substrate and results in a temporary adhesion of the powder to the substrate surface. After melting and curing the powder layer, a continuous film on the substrate is formed. The conductivity of metal substrates is important for the success of powder coatings. Therefore, it is necessary to pre-treat the substrate surface prior to coating.

The pre-treatment of metallic substrates, such as, steel or aluminum substrates generally consists of at least several processing steps, such as, removal of fats and oils or other impurities by alkaline washing, followed by a wet-chemical deposit of inorganic corrosion protection layer (phosphating, chrometizing), washing and drying the metal surface before the subsequent application of the powder in order to avoid coating faults, see T. Molz, Tagungsband der DFO-Pulverlacktagung, 23.-24.09.1996, pages 201-207. This pre-treatment process required considerable investment and operation costs. U.S. Pat. No. 6,280,800 relates to a process for coating metallic substrate surfaces under that pre-treats the substrate with high-energy NIR radiation to improve the adhesion of the coating and improve appearance and performance of the coating. Particularly with regard to thick substrates, such as, metal substrates having a thickness of 3 mm or higher, there are often problems in regard to the adhesion of the powder coating to the substrate surface.

The use of powder coatings to coat non-metallic substrates is much more difficult than coating metallic substrates with powder coatings due to the insufficient surface conductivity of the substrate and inefficient grounding of the substrate. As a result, the powder coating is deposited unevenly and the adhesion of the powder coating to the substrate is poor.

It is known to pre-treat wood-based substrates with a liquid conductive primer prior to the application of powder, see H. Bauch, JOT 1998, Vol. 10, p. 40 ff. Other proposed processes for pre-treatment of non-conductive substrates comprise drying the substrate via high-frequency alternating voltage, or pre-heating of, e.g., MDF boards with microwaves prior to the application of a powder, as described in DE-A 195 33 858. Other processes which have been used are spraying the surface of non-metallic substrates with water prior to coating or exposing the substrate to dry heat and then applying the powder onto the hot surface, see, e.g., EP-A 933 140.

However, these processes require an additional coating step, are expensive or present problems in obtaining uniform coatings particularly on structural substrates. There can be difficulties in heating large objects evenly, such as, MDF boards, or problems, such as, the formation of water vapor under the powder film during the curing process that cause porosity and poor adhesion. Often, the edges of such boards are not covered sufficiently due to heat loss.

### SUMMARY OF THE INVENTION

This invention is directed to a process for application of powder coatings to conductive and non-conductive substrates, such as, thick metal substrates, transparent organic and inorganic substrates and temperature sensitive substrates by first covering the substrate surface with specific materials which absorb high-energy radiation within a wavelength in the range of 250 to 2,500 nm and having high heating rates in the range of more than 50° C. per second during melting and curing of the powder coating compositions and then applying a powder coating composition to the covered surface and melting and curing the applied powder coating composition with NIR radiation.

The process according to this invention utilizes NIR radiation to increase the temperature within the substrate surface and the powder coating melts and perfect wetting of the substrate occurs and a faultless coating is formed having excellent adhesion to the surface of the substrate, in particular, to thick metal substrates, transparent and inorganic substrates and temperature sensitive substrates. Particular advantages of this invention are that the melting and curing time range of the powder coating compositions applied to the substrate surface are significantly shorter in comparison to conventional powder coating methods.

### DETAILED DESCRIPTION OF THE INVENTION

In the process of this invention, the surface of the substrate is covered with materials which absorb the high-energy radiation in a range of 250 to 2,500 nm, followed by electrostatic application of a powder coating composition to the covered substrate. These materials show specific properties relating to the absorption of high energy radiation in a wavelength range between 250 and 2,500 nm and have a high level of adhesion to the surface of the substrate and the powder coating composition.

The materials, according to the invention, which absorb the high-energy radiation in a range of 250 to 2,500 nm are as follows: carbon and carbon modification, such as, graphite, magnetite, metal oxides, such as, iron oxide, iron oxide black, tin oxide, antimony oxide and combinations there from. Preferably, carbon and graphite are used.

The heating rate of these materials applied to the substrate surface is within the range of more than 50° C. per second, preferred are heating rates in the range of more than 65° C. per second.

It is essential in the process of this invention to apply the material, according to the invention, in that way that the surface of the substrate is completely and uniformly covered with these materials. It is possible to apply the material, according to the invention, under specific conditions, for example environment temperature or under higher temperature by e.g. flaming or in-moulding procedures. The materials may be applicable to the surface in layer thicknesses in the range of, for example 0.1 to 10 μm, preferably, 0.1 to 1 μm.

It is also possible to apply the materials, according to the invention, by means of a primer coating. The materials can be incorporated into a conventional primer based on, for example, epoxy resins or acrylate resins followed by the powder coating process. The amounts of the material in the primer may be in the range of the conventional amounts of pigments in coating compositions, for example, between 0.5 to 10 wt %.

After covering the substrate surface with the material, according to the invention, a powder coating composition is applied to the covered substrate surface. The temperature of the substrate surface during the powder application can be between room temperature and 90° C. with regard to electrical conductive substrates. It is preferred to apply the powder at a surface temperature below the glass transition temperature of the powder coating material. Typical powder coating glass transition temperatures are between 45 and 70° C.

Non-conductive substrates are coated at a surface temperature more than 60° C., preferably 80 to 110° C.

It is preferred to apply the powder coating immediately after covering the surface, according to the invention.

The powder coating composition used in the process, according to the invention, can be any radiation curing powder that is suitable for the substrate comprising the known powder binders, cross-linking agents, pigments and/or additives. The subsequent coating with a powder coating composition can be carried out, where appropriate as a one-layer coating or a multi-layer coating. The melting and curing of the coating layers can be carried out by means of NIR-radiation alone or in combination with other methods, such as, UV-radiation or electronic beam. The combination with thermal curing is also usable such as by means of convection heating. The melting and curing with NIR radiation is used in preference.

Powder coating compositions that are suitable for being cured by means of NIR radiation are described in WO 99/41323. The powder coating compositions can be cured with UV/electronic beam and/or NIR/IR radiation as described, e.g. in EP-A 739 922, 702 067 and 636 660.

Halogen lamps, especially high-performance halogen lamps, can be used as the NIR source, e.g. halogen lamps emitting in the wavelength range for example between 800 and 1200 nm. The applied powder coating composition may, for example, be cured using conventional high-energy NIR radiation emitters. It is, for example, possible to use NIR radiation emitters with an emitter surface temperature of the incandescent filament of between 2000 and 3500 K, with an intensity, for example, more than 1 W/cm², preferably, more than 10 W/cm².

The total irradiation period may, for example, be within a range from 0.5 to 60 seconds, preferably, from 1 to 10 seconds.

The powder coating compositions usable, according to the invention, also may contain conventional binder curing agent systems, such as, for example, polyester resins with low molecular weight, epoxy and/or hydroxy alcyl amide curing agents and/or dimerized isocyanates and/or blocked isocyanates, epoxy/polyester hybrid systems, epoxy resins with dicyandiamide curing agents, carboxylic acid curing agents or phenolic curing agents, or also epoxy-functionalized acrylate resins with carboxylic acid or carboxylic anhydride curing agents, together with conventional pigments and/or extenders in conventional coating additives. The powder coating compositions may be colored using conventional organic or inorganic pigments or dyes as well as metallic and/or non-metallic special effect imparting agents. They can also be un-colored.

The powder coatings usable, according to the invention, may be produced in conventional manner, for example, using non-extrusion/grinding/grinding processes, production of powders by spraying from supercritical solutions, NAD processes or ultrasonic standing wave atomisation process. The powder may be applied onto the substrate to be coated using known electrostatic spraying processes, for example, using corona or tribo principle based spray guns or with other suitable powder application processes, for example, application in the form of an aqueous dispersion (powder slurry) or by means of broad band spreading processes.

The process, according to the invention, is particularly suitable for covering and coating metal substrates having thick-walled proportions, for example, having a thickness of 3 mm or more. Substrates that may be used are, for example, metals, such as, aluminum, steel, glass, ceramics as well as wood or plastic surfaces. In particular, especially three-dimensional objects with thick walls may also be treated by the process, according to the invention.

The metal substrate surfaces can be covered and coated according to the invention directly, but they can also be pre-coated, e.g., with an inorganic corrosion protection layer by, e.g. phosphating or chrometizing procedures, prior to covering and coating.

The process, according to the invention, is also suitable for transparent organic and inorganic substrates usually not suitable for NIR irradiation, and, is also suitable for temperature sensitive materials, which require specific pre-treatment procedures prior to application of a powder coating composition.

The coatings obtained using the process, according to the invention, have an excellent adhesion to the substrate surface, and, apart from that, improved flow properties and a shorter curing time.

The following examples illustrate the invention.

### EXAMPLES

### Example 1

Outdoor resistant powder coating composition based on polyester resin 62.6 wt % of the polyester resin Alftalat® 03640 (saturated carboxy functional polyester), is mixed in an extruder device together with 4.86 wt % of the hardener Araldit PT 910 (mixture of di- and trifunctional glycidylester), 3.3 wt % of the flow-and degassing additives Benzoin® (benzoyl phenoyl carbinol), and Additol® VXL 9824 (saturated hydroxyl functional polyester), 4.3 wt % of the filler Blanc fixe® (barium sulfate), 25 wt % Ti-pure® 960 (titanium dioxide pigment), at temperatures between 80 and 120° C. The extrudate resulting is sheeted out as film of about 1 to 2 mm thickness using a cooled press roll and cooled down to about 35° C. The film is broken into small chips by means of a crusher and then pulverized to a powder.

### Example 2

Powder coating composition based on an epoxy resin 57.2 wt % of the epoxy resin Epon® 1002 (reaction product of epichlorhydrin and Bisphenol A), 17.1 wt % of the hardener HT 3082 (Bisphenol A), 0.7 wt % of the flow agent Resiflow® PV 88 (polyacrylate adsorbed at silica carrier), 3 wt % of the filler Blanc fixe, 22 wt % Ti-pure® 960 are mixed together in an extruder device, at temperatures between 80 and 120° C. The extrudate resulting is sheeted out as film of about 1 to 2 mm thickness using a cooled press roll and cooled down to about 35° C. The film is broken into small chips by means of a crusher and then pulverized to a powder.

### Example 3

Covering procedure, application of powder and measurement of the surface properties

10 mm thick aluminum sheets were covered by flaming the sheets with carbon in a layer thickness of approximately 0.5 to 1 μm. The powder coating compositions were applied to the treated sheets in conventional film thickness of on average 60 to 80 μm and were melted and cured by means of NIR irradiation for 6 seconds. The results are shown in Table 1 below.

TABLE 1

| Parameters | Without Carbon Covering | With Carbon Covering |
|---|---|---|
| Adhesiveness | 3 | 0 |
| DIN EN 2409 | | |
| (Lattice Cut) | | |
| Flow (Wave Scan) | Long Wave: 40-50 | Long Wave: <20 |
| Impact-Test (inchp) | Example 1: <20 | >40 |
| (ASTM D 2794) | Example 2: <20 | >60 |
| Curing Time with | 13 seconds | 5 seconds |
| NIR radiation | | |
| Flexibility (DIN EN | Example 1: >10 | <3 |
| ISO 1519) | Example 2: >8 | <3 |

We claim:

1. A process for application of powder coatings to conductive and non-conductive surfaces comprising
a) covering the surface with material which absorbs high-energy radiation within a wavelength in the range of 250 to 2,500 nm and having heating rates of more than 50° C. per second and
b) applying a powder coating composition to the covered surface and melting and curing the applied powder coating composition with NIR radiation.

2. The process according to claim 1 wherein the material is selected from the group consisting of carbon, graphite, magnetite, iron oxide, iron oxide black, tin oxide and antimony oxide.

3. The process according to claim 2 wherein the material is selected from the group consisting of carbon and graphite.

4. The process according to claim 1 wherein the heating rate is in the range of more than 65° C. per second.

5. The process according to claim 1 wherein the covering step is realized by means of flaming or in-moulding procedures and with a layer thickness in the range of 0.1 to 10 μm.

6. The process according to claim 5 wherein the covering step is realized with a layer thickness in the range of 0.5 to 1 μm.

7. The process according to claim 1 wherein step (b) follows immediately after step (a).

8. The process according to claim 1 wherein NIR irradiation at a wavelength between 800 and 1200 nm and with an intensity of more than 1 W/cm² is used to melt and cure the coating composition.

9. The process according to claim 1 wherein a combination of NIR radiation and UV radiation is used to melt and cure the coating composition.

10. The process according to claim 1 wherein the surface is selected from the group of metal substrates, transparent organic and inorganic substrates and temperature sensitive substrates.

11. The process according to claim 10 wherein the surface is a thick metal substrate having a thickness of 3 mm or more.

12. A coated surface prepared by a process wherein the surface is covered with material which absorb high-energy radiation within a wavelength in the range of 250 to 2,500 nm and having a heating rate of more than 50° C. per second; and then applying a powder coating composition to the covered surface and melting and curing the applied powder coating composition with NIR radiation.
